(19) United States
(12) Patent Application Publication
(10) Pub. No.: US 2014/0104421 A1
(43) Pub. Date: Apr. 17, 2014

(54) MONITORING SYSTEM FOR REMOTELY SUPERVISING AND CONTROLLING CRITICAL OPERATIONS AND METHOD FOR DETECTING IMAGE FREEZING

(71) Applicant: Alberto Adarve Lozano, Madrid (ES)

(72) Inventor: Alberto Adarve Lozano, Madrid (ES)

(21) Appl. No.: 14/112,034

(22) PCT Filed: Mar. 27, 2012
(86) PCT No.: PCT/ES12/70207

§ 371 Date: Dec. 16, 2013

(30) Foreign Application Priority Data
Apr. 14, 2011 (ES) 201130595

(51) Int. Cl. H04N 7/18

(52) U.S. Cl. CPC H04N 7/185
USPC 348/144

(57) ABSTRACT

Monitoring system for remotely supervising and controlling critical operations and algorithm for detecting image freezing, consisting of a system for displaying images from a set of sensors in real time, with the ability to detect the freezing of part or all of the imput video signal and to detect the failure or non-existance of an input video signal in order to inform the operator by means of sound, indicating lights or overlays on the display, and with the ability to select an alternative video signal input in order to avoid the operator being able to lose sight of the images of the real world being displayed or to avoid a delay being produced in the viewing of such images. The invention also relates to an algorithm for performing the above functionalities on the basis of the use of one or more computing units.

### FIELD OF THE INVENTION

The present invention relates to a video monitoring system in real-time for monitoring critical operations such as in flight refueling or of any other means of a remote control or the supervision of operations where the lapse of time which is between the real action and the remote visualization of the same is absolutely fundamental for the success of the operation.

### BACKGROUND OF THE INVENTION

Currently the methods of conventional visualization for critical operations through a remote control are based on the use of presentation elements as liquid crystal displays (lcd) or similar and projectors which provide a picture of the remote operation to an operator who is to control based on the insight obtained that the operation is performed and finished correctly. These operations are characterized as critical because the operator has no direct view of the course of the operation and obtains this vision based on a complex video system, which provides the necessary understanding for completing the same to the operator. Such operations require a perfect vision in real-time and where such vision is not present this can give cause to accidents.

The known systems used and electronic annexed system which in general has a video signal input in a standardized format. If the video signal is of quality, then it is usually by way of high-resolution video cameras or photon sensors located at the end of the device control by the operator, which allows the operator to make decisions about the position, the distance and other parameters necessary for the correct finalization of the operation with success. The signal emitted by cameras and/or sensors travels across a set of the digital lines in order to transmit the data to the presentation location of either the panel display, the screen or the presentation device.

A typical example of these operations is the refueling of fuel of aircraft in flight. In the case of cameras, this signal is connected in sensors, which are impacted by photons coming from the objects of the environment to produce an electrical signal which travels through channels to a point of image processing where the image is treated to be then anew send across said channels to at least one monitor where the electronics of the monitor receives the image and sends the image to at least one visualization device. The systems of flight refueling are based on the use of three types of devices such as:
Hose and Drogue: consisting in the use of a hose ending in a funnel shaped basket as an interconnecting device between a tanker plane and a receiver or several, in flight.
FRU (Fuselage Refueling Unit): similar to the above where a central hose is of a larger size than usually is employed for the refueling.
Boom: a device consists basically of a telescopic and extensible tube attached the option of the tanker by a hinge element and which is movable thanks to some fins by inserting a “nozzle” at the end of the tube into the receptacle of the receiving plane in order to then supply fuel.

All of these are intended to facilitate the passage of fuel from the tanker plane to a receiver plane. This type of refueling operation as well as other real-time operations are characterized in requiring a low latency between the real successes and their remote visualization in the corresponding monitor.

Considered operations are treated as critical where from a remote location, the operator visually controls all of the steps and procedures to guarantee the success of the mission by operating in real-time from a set of devices and controls, and manipulate all of these devices about the base of the visual information which he receives until the operation is performed. This vision control is carried out indirectly normally through electronic means, which produces a delay between the success and the visualization of the success, and the delay should be the minimum possible delay.

Whether in bunkering operations in flight or on any other of such similar requirement or critical characteristics, which also require consideration and minimize the delay between the actual success and the visualization of the success, it is fundamental to consider and evaluate the effect which a freeze of the images can have for the operator who visualizes the images. The time unto it gets to be determined that there really is a freeze and that in the following it is necessary to follow up the procedure established for such situations can be performed or potentially lead to catastrophic results.

Similar operations also perform all types of military devices or not and which have a certain mode with some type of remote control. Not only in the cases mentioned above which use any of the systems which were previously indicated but also in any other situation in which remote operation which require vision in real-time as closely as possible to the moment when the actual event occurs, it is essential to guarantee that the images of the video frames flow without interruption from the camera to the final presentation device, where the supervisor shall use this information in order to make decisions as to what to do and how to manipulate the operational controls.

Since in many cases it is not acceptable to have a considerably delay between the time at which events occur and that time in which actually images of the same reach the operator, the capacity necessary to detect if the signal coming from the image sensors has been frozen and in the capability to switch from one input signal to another signal in case one has this alternative available. Both capabilities belong to the object of the present invention.

In some cases cameras are utilized with a refresh rate used different from the refresh rate required to feed the monitor with the purpose to avoid flickering or other similar and undesirable effects in the presentation. For having the correct number of boxes needed by the display image, the buffer memory is used for temporarily storing data and they can be repeated up to the desired frequency.

Also sometimes cameras or other devices that are on the route to the final presentation require some image processing that requires the use of a picture storage memory, to which are applied a series of mathematical transformations for obtaining the desired results.

At other times and in order to increase the sensitivity of the sensors it is necessary to increase the size of the sensor pixels using some type of grouping of the basic pixels of the sensor or “binning”, which ends up leading to the new need for employing a memory for storing the pixels.

In either of the prior cases and in other similar cases, the existence of a memory for storing the data of the image carries a risk of the freezing of the image in the final presentation device. This can translate into a malfunctioning of the system, which consists of a blocking or freezing of the whole or part video image, which causes an undesirable delay between the real event and the vision which the operator has of the event.

This delay can generate a disaster since it is completely unacceptable in many applications from the point of view of the safety, where no mechanism of detection, indication and even subsequent selection of a video image alternative in order to avoid losing the view of the real work scene. Another optional improvement introduced in the present invention consists precisely in the employment of various alternative sources of the video signal coming from certain sensors. Once the freezing or the loss of video is detected, the system can switch between them for ensuring that always there exists a living image in real-time and with which one can work.

Even in the 3-D systems, where two images are superposed for obtaining a mixture of two corresponding images one for each eye and that spectacles are responsible for distributing conveniently, it is interesting to ensure that where a sensor image that is frozen or remains disappeared, the system continues creating something that does not disturb or entice the user. In case of failure of any image for loss or freeze of the system, the system automatically switches to a 2D image based on a repeat for both eyes of the image that still remains alive. This allows in the majority of cases to continue with the operation without a major problem.

The importance of the system is that if there are no alternative input signals to at least inform the user of the freezing for allowing to save precious time to make a decision how to follow up.

In such critical operations, the supervision or control operator cannot lose time because loss of time may create earliest to the success of the operation and cause an accident. Therefore in situations of signal programs as described above, a monitoring system that not only of all its been frozen images, but also reports and chooses the source file are properties much to be considered and are objects of the present invention.

Furthermore, if a cable or transfer medium for the signal is interrupted or damages the system, then this system also has to detect the loss of signal analyzing the integrity of the system.

What is proposed in the present invention is a system of monitorization, which in its most basic form reduces to a simple monitor, redundant and robust from a functional type that is all its all potential mentioned above. In more advanced versions also described in this invention it is provided with several display elements the 3-D vision of the events and can switch to 2D in case of failure in any of the input video signals.

The present invention has an object to solve the potential problems based on electronic design for the said cases, which situations deliver the desired characteristics. At the same time a method of procedure in order to detect the freezing is proposed.

### SHORT DESCRIPTION OF THE INVENTION

According to a first aspect the present invention is directed to a supervision system of critical operations, wherein the loss or the freezing of the image is not acceptable and can compromise the success of the mission or of the task.

The system is composed of all or several of the following elements:
one or several devices for the acquiring of the video images, preferably cameras or photon sensors.
one or more conventional devices for the treatment of the images.
one or more boxes which house all the electronic devices and image display systems if necessary.
a visual panel or any other presentation device for showing the images.
an electronics for obtaining some or all the following characteristics.
a redundant power supply.
various inputs for the administration of energy.
various inputs for the video signal.
a subsystem detecting if the received video is correct.
a subsystem stopping frozen images or part of images.
a switching subsystem for selecting an alternative input for the video signal.
a subsystem for the generation of overlays or graphic indications on the display screen or visual panel.
a subsystem of user information of any system failure.
ancillary signaling elements such as lights or sound (based on LEDs or similar).
subsystem of external communications for sending additional information about the status, errors and systems operation.
an algorithm which controls in an automatic form one or all of the characteristics recited above.

Implementation of all previous sub systems can be engaged with one or more of the above features, but it is important not to input errors such as freezing or video signal loss.

An implementation example of the above is reflected in FIG. 1.

In accordance with the invention, the images sent to the display will not, by virtue of its proper design, the ability to freeze, but if this happened because of an input error in the input video signal from outside the system, the last stage is responsible for detecting and switching to another suitable signal which presents no such dysfunction. Equally informs immediately and in different forms the operator about such situations that it can certainly take appropriate remedial actions without doubt.

The possibility of this system to automatically select between the input video signal by finding that does not contain the problems relating to freezing error or signal loss detection is an obvious advantage of the invention. For obvious reasons it is recommended that the input signals are different, distinct and independent.

According to another aspect of the invention a method is proposed for performing the functions of detection of freezing through a crypto algorithm codified for it.

### BRIEF DESCRIPTION OF THE DRAWING

The foregoing object and many of the advantages of this invention may become more appreciated and more clearly understood by the detailed description of the invention, which follows in conjunction with the figures and subsequent inserted drawing in which:

FIG. 1 shows a detailed schematic view of the components of the system object of the invention.

FIG. 2 shows a schematic view more general of the vision system from the input sensors, where the real world images are connected in chambers (25) and are processed in the picture processing systems (24) and send to system end display (11) and (12) and in which the user will get an appropriate information about the environment or the operating scenario.

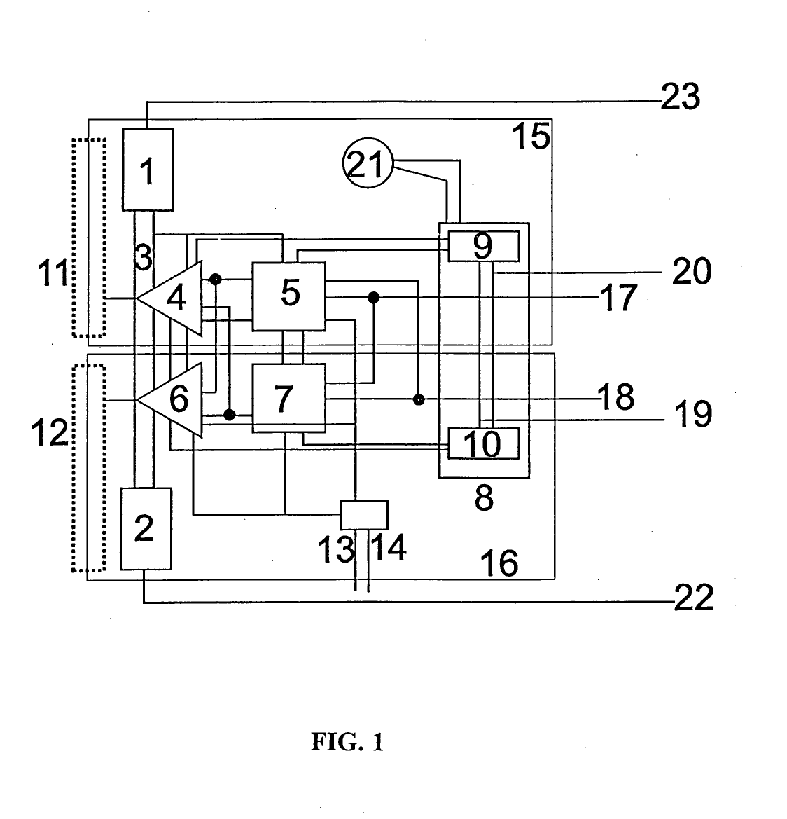

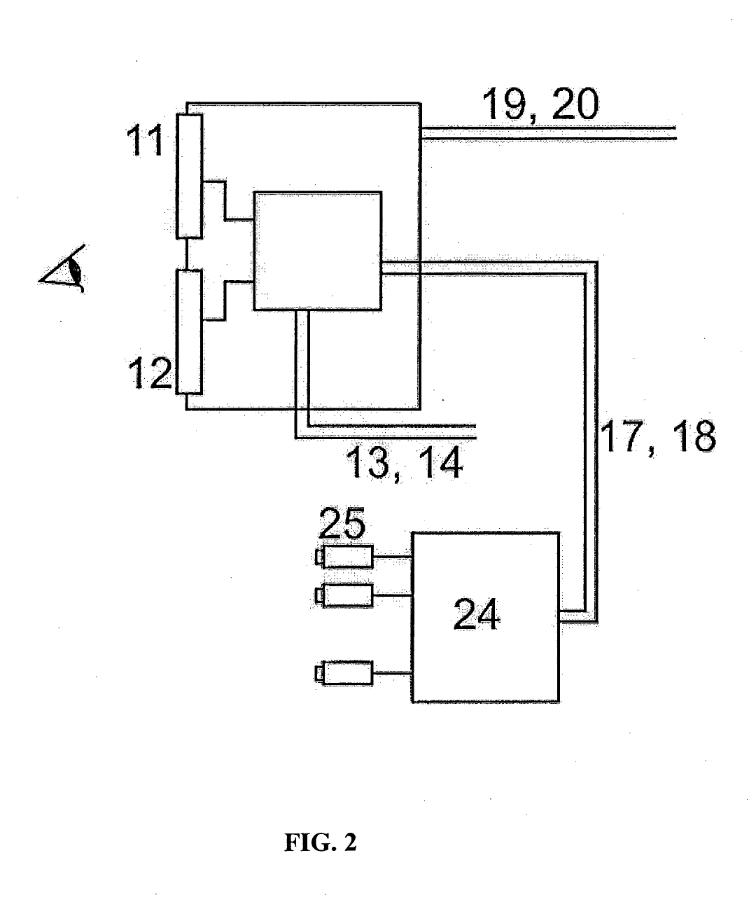

The object of the present invention will be represented schematically in FIG. 1 for the numbered elements with the exception of the elements of the reference numerals 11 and 12, which would well form part of the included system by including in the same boxes (15) and (16), do not form part of the invention.

### DETAILED DESCRIPTION OF THE INVENTION

When using a monitor to oversee critical operations there are no requirements and object to be met apart from brightness, from intensity and so on and are independent even of the picture quality. The most important of all is to avoid the risks and damages which can be a consequence of the loss or the freezing total or partial of its image. The objects are to be met by the key features of the present invention:

First by a reliable design, images cannot freeze physically within the system. This then be achieved by analyzing the signal which feeds and controls an internal storage memory and by a configuration and use of the same for a proceeding of the type ping-pong as well as with the use of several auxiliary registers which warrant to us the final objective of no internal freezing.

However this characteristic is convenient and interesting, it does not form the main object of this invention. In a second place by way of the creation of an electronics mechanism, which is located in the last stage between the presentation device and the remainder of the system, which detects any frozen part of the image and informs the user about this fact. Therefore, the present invention proposes to obtain and store parts of the image frame which can compare with the following frames and the result of which is used for determining the existence or absence of freezing. This detection is realized, as was said before, in the last stage of this system, prior to sending the signal to the display screen or display end device. If it is not possible to correct the internal freezing in determining, this detection will inform us of the existence of freezing in the input of the video signal used by way of a panel of lights and/or sound. This is the essential basic idea of the present invention.

In third place, by an additional electronic mechanism of selection activated by an algorithm which detects on the one hand a frozen image, changes to a different input or, alternatively, where there is no source of additional video, proceeds to inform the operator in different ways about this situation. In this case the operator proceeds according to the procedures established to avoid any negative consequence which could derive from this situation.

Electronic mechanisms can be implemented thanks to one or several FPGAs or included with the help of one of various micro-controllers or processors.

Proposed ways, but not exclusively for informing the operator, use overlays are generated by the proper electronics and the use of indicator lights and/or sounds. The operator should always take into account the means to be taken as a function of this information, which can include the abortion of the mission.

It is also important to consider the redundancy of the various system resources and in this sense the present invention provides in one of its redundant claims other resources which compose it.

Another improvement introduced into the system of monitorization and being that object of the present invention is the employment of redundant series signals for control and video, and independent of the redundancy of the remaining elements and functionalities. Examples of these format would have preferred implementation based on RS422 for the commands and data and a HD-SDI video signal. This type of format allows an easy selection and also an easy conversion to optics, improving to a large extent the box of the signals and reducing the probability of error in said channels. This will translate into an additional benefit that will position the supply item at a great distance from the rest of the system that provides the signals to be displayed.

The commands for controlling aspects such as brightness or intensity of color can be sent through a serial line or embedded in the same serial link video and at the ancillary nature which would reduce the input to this system.

This system relies on the use of the following elements:
Video acquisition means (25), which may be cameras or photon sensors or any other that allow real-time imaging.
A conventional system for the treatment of images (24).
A box or sets of boxes (15) and (16), where most of the elements will be housed and protected.
Signal converters (4) and (6) to convert the input image data in the appropriate format to the screen display elements (11) or (12) to be displayed.
Signal processors (5) and (7) to be implemented for example with FPGAs, full obtaining the information of the images which are entered through (17) and/or (18), analyzed for detecting any symptoms of freezing or of loss of image and to create an overlay on the screens and send an indication to the lights (21) to alert the user of this situation. The electronics must also take control and select another input where available that does not have the above errors. This functionality may make it by way of one or more micro controllers (9) or (10), which will act as one in a master/slave configuration as shown in the figure with (8).
Redundant power supplies fed by lines (22) and (23), represented by (1) and (2), to behave as a single (3) to power or the other elements and that in case of failure of any one of them would not only be detected and reported, but also continue to provide feeding to this system whenever any one of them is still alive.
Reset inputs (13) and (14) that in extreme cases hang with gamma or high electromagnetic fields, will permit to reset the system from the outside.

All events, including errors and failures to be detected and reported by the hardware blocks (8) formed by one or more processors through two (for redundancy) interfaces as shown in the figure as (19) and (20).

The warning lights malfunction (21), which can be the in the LEDs, are redundant for any indication that pretends to give and their mission is to report any event otherwise transcendent in another form.

According to a second aspect, the invention is materialized in part by implementing a method of detecting the freezing and the lack of the video, that will be implemented using the corresponding algorithm, in such a way that the algorithm comprises the following steps:

a) initialization of variables

b) detecting the lack of video

c) detection of freezing

d) in case of either one of the above two errors, as the selection of an alternative input if it exists, and indication of such an acoustic and/or shining as the generation of overlays on the image of the screen(s).

According to a preferred embodiment this algorithm is implemented in FPGA although the electronics could be programmed into a micro controller or in another similar form.

The freezing is detected basically in storage of certain areas of the panel picture for comparing them with the corresponding subsequent panels, and later calculating the number of matches to conclude that there was a sufficient or insufficient matches for suspecting and indicating the existence of freezing.

Although the present invention has been fully described in a general area and sometimes particularized in some cases with options, certain uses and in the preferred implementations, it is obvious that the modifications or details, which can have been introduced into the determined area, shall be considered neither as different embodiments nor as usage limitations of the determined area.

1-23. (canceled)

24. A remote monitorization system for the supervision and control of critical operations applicable for the visualization of video images in real time and to prevent total or partial freezing of said video images, which are of the type which considers at least a capturing device of video images in real time, at least a conventional system of treating the said images, at least a visual display such as a panel display of the screen (lcd or similar) or an image projector for generating original images at least a remote capturing device of images (sensor), and one or several boxes where to place said elements,
characterized wherein one calculates with an electronics, for adapting the input signal to that required for the visual display, and which applies a detection algorithm of the freezing, as well as informing the user about this situation in real time, wherein the said algorithm is basically structured in a storage procedure of partial panel information and for comparing of the same with that of the following panel or panels
in order to deduce the existence of freezing from this result.

25. The remote monitorization system for the supervision and control of critical operations according to claim 24, wherein the system is configured so that the electronics can also detect a loss of video signal.

26. The remote monitorization system for the supervision and control of critical operations according to claim 24, characterized by being further comprised of more than one video input and because one selects one of said video inputs when a failure of freezing or loss of image is detected.

27. The remote monitorization system for the supervision and control of critical operations according to claim 24, characterized by being configured so that the electronics can also report by other means such as lights or serial communications about loss and/or freezing of the input video signal.

28. The remote monitorization system for the supervision and control of critical operations according to claim 24, characterized by being provided with additional redundancy in one, or several components of the system.

29. The remote monitorization system for the supervision and control of critical operations according to claim 28, characterized in that the redundant additional component is the feeding source.

30. The remote monitorization system for the supervision and control of critical operations according to claim 28, characterized in that the redundant additional component is the supervising system.

31. The remote monitorization system for the supervision and control of critical operations according to claim 28, characterized in that the redundant additional component is the LCD panel.

32. The remote monitorization system for the supervision and control of critical operations according to claim 28, characterized in that the redundant additional component is the image projector.

33. The remote monitorization system for the supervision and control of critical operations according to claim 28, characterized in that the redundant additional component is the display presentation system.

34. The remote monitorization system for the supervision and control of critical operations according to claim 28, characterized in that the redundant additional component is the input signal selector.

35. The remote monitorization system for the supervision and control of critical operations according to claim 24, characterized in that its video inputs are of the serial type of video to facilitate multiplexing or selecting among the same and for easy conversion to optical.

36. The remote monitorization system for the supervision and control of critical operations according to claim 24, characterized in that its video inputs for video and communication with the outside are included in a single signal thereby leaving the control commands and data from this multiplexed system remain for said same channel.

37. The remote monitorization system for the supervision and control of critical operations according to claim 24, characterized by having video inputs and optical data.

38. The remote monitorization system for the supervision and control of critical operations according to claim 24, characterized by having some panels of lcd type disposed adjacent to battery of the form that when one of them fails, the other can take its place in an automatic stay behind it being able to even see its image through the front side.

39. The remote monitorization system for the supervision and control of critical operations according to claim 24, wherein the means for displaying the images are more image projectors, projection screens.

40. The remote monitorization system for the supervision and control of critical operations according to claim 24, characterized by being used for aerial refueling operations in flight.

41. The remote monitorization system for the supervision and control of critical operations according to claim 24, characterized by disposing an electronics which shows overlays by way of the modification of the values of the video input data corresponding to each one of the pixels of the image signal prior to sending them to the output connector of the signal, wherein said modification is made in the electronics which receives said input information (fpga or processor) and the overlays generated appear over the image for supplying additional information to the user.

42. The remote monitorization system for the supervision and control of critical operations according to claim 24, characterized by additionally having light and/or sound of auxiliary and redundant information to inform the user.

43. The remote monitorization system for the supervision and control of critical operations according to claim 42, wherein the redundant information lights to inform the user are LEDs.

44. The remote monitorization system for the supervision and control of critical operations according to claim 24, further provided with one or more internal micro-controllers to inform the outside about the activity, the state and mode of operation of the system.

45. The remote monitorization system for the supervision and control of critical operations according to claim 27, wherein the communication channel is also used to receive commands and instructions from outside in order to modify its behavior.

46. The remote monitorization system for the supervision and control of critical operations according to claim 45, wherein the communications channel is redundant.

47. The remote monitorization system for the supervision and control of critical operations according to claim 44, wherein also an input for reprogramming or reconfiguring of micro-controllers and fpgas and their electronics from the outside.

48. The remote monitorization system for the supervision and control of critical operations according to claim 24, wherein two presentation displays are employed for generating a 3D image, and when an image of a monitor entry fails, then its input exchange to another image and therefore has the advantage of allowing the operator to follow viewing images that do not bother the operator or that do not involve the loss of vision in either eye.

49. The detection method for freezing of images in a remote monitoring system for supervising and controlling of critical operations, according to claim 24, characterized in that it carries the goal by way of an algorithm which comprises the following steps:
a) initializing the variables,
b) detecting the failing of the video,
c) detecting of freezing,
d) in case of any of the two preceding errors, selecting an input alternative, when there exists such a full acoustical and/or luminescent indication.

50. The detection method for freezing of images according to claim 49, characterized in that the algorithm detects the existence of a correct video signal or of an incorrect video signal and provides a calculation of the discrepancies obtained from a comparison of the received information in the storage of the determined parts or of the pixels as a whole of a panel or panels of the input signal and compares the similar parts or pixels as a whole of the actual panel or following storages according to the earlier point.

51. The detection method for freezing of images according to claim 49, characterized in that it also has the ability to exchange between the video input signals.

52. The detection method for freezing of images according to claim 49, wherein the algorithm generates overlays of information superimposed to the image for reporting the system state.
